(19) United States
(12) Patent Application Publication
(10) Pub. No.: US 2017/0111458 A1
(43) Pub. Date: Apr. 20, 2017

(54) SYSTEMS AND METHODS FOR PROVIDING DESTINATION SUGGESTIONS

(71) Applicant: Facebook, Inc., Menlo Park, CA (US)

(72) Inventors: Yu Huang, Mountain View, CA (US); He Zhang, Fremont, CA (US); Zhiyang Wang, Mountain View, CA (US)

(21) Appl. No.: 14/882,898

(22) Filed: Oct. 14, 2015

(51) Int. Cl. H04L 29/08; H04L 12/58; G06F 17/30

(52) U.S. Cl. CPC H04L 67/18; G06F 17/3053; H04L 51/32

(57) ABSTRACT

Systems, methods, and non-transitory computer-readable media can receive travel information including at least one of a travel duration, dates of travel, or a particular destination. One or more potential travel destinations are determined based on the travel information. For each of the one or more potential travel destinations, one or more connections who have previously visited or lived in the potential travel destination are determined. For each of the one or more potential travel destinations, the one or more connections who have previously visited or lived in the potential travel destination are ranked.

### FIELD OF THE INVENTION

The present disclosure relates to the field of social networks. More particularly, the present disclosure relates to techniques for providing travel assistance.

### BACKGROUND

Today, people often utilize computing devices (or systems) for a wide variety of purposes. Users can use their computing devices, for example, to interact with one another, create content, share content, and view content. In some cases, a user can utilize his or her computing device to access a social networking system (or service). The user can provide, post, share, and access various content items, such as status updates, images, videos, articles, and links, via the social networking system.

User experience associated with a social networking system can be enhanced as the social networking system becomes more knowledgeable about the users that it serves. When knowledge of a user is gained, content, advertising, and potentially other services can be optimized for presentation to the user. Such potentially helpful knowledge about the user can include information about the user, as well as information about the user's connections and contacts.

### SUMMARY

Various embodiments of the present disclosure can include systems, methods, and non-transitory computer readable media configured to receive travel information including at least one of a travel duration, dates of travel, or a particular destination. One or more potential travel destinations are determined based on the travel information. For each of the one or more potential travel destinations, one or more connections who have previously visited or lived in the potential travel destination are determined. For each of the one or more potential travel destinations, the one or more connections who have previously visited or lived in the potential travel destination are ranked.

In an embodiment, the travel information comprises a particular destination. A first list of connections comprising one or more connections who have previously visited the potential travel destination is presented; and a second list of connections comprising one or more connections who have lived in the potential travel destination is presented.

In an embodiment, the one or more potential travel destinations are ranked based on destination ranking criteria.

In an embodiment, the destination ranking criteria comprise the dates of travel. The one or more potential travel destinations are ranked based on a popularity of each of the one or more potential travel destinations during the dates of travel.

In an embodiment, the destination ranking criteria comprise user residence location information.

In an embodiment, the destination ranking criteria further comprise the travel duration. The ranking of the one or more potential travel destinations comprises determining whether a trip to a potential travel destination is practical based on the user residence location information and the travel duration.

In an embodiment, the connection ranking criteria comprise a friendship coefficient.

In an embodiment, the connection ranking criteria comprise destination familiarity information.

In an embodiment, an option is provided to message at least one of the one or more connections.

In an embodiment, an option is provided to invite at least one of the one or more connections to participate in a post related to at least one of the one or more potential travel destinations.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the disclosed technology.

### BRIEF DESCRIPTION OF THE DRAWINGS

FIG. 1 illustrates an example system including an example travel assistance module, according to an embodiment of the present disclosure.

FIG. 2 illustrates an example destination suggestion module, according to an embodiment of the present disclosure.

FIG. 3 illustrates an example destination search module, according to an embodiment of the present disclosure.

FIG. 4 illustrates an example scenario including an example destination suggestion interface, according to an embodiment of the present disclosure.

FIG. 5 illustrates an example method to provide destination suggestions, according to an embodiment of the present disclosure.

FIG. 6 illustrates an example method to provide travel assistance for a particular travel destination, according to an embodiment of the present disclosure.

FIG. 7 illustrates a network diagram of an example system including an example social networking system that can be utilized in various scenarios, according to an embodiment of the present disclosure.

FIG. 8 illustrates an example of a computer system or computing device that can be utilized in various scenarios, according to an embodiment of the present disclosure.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

### Destination Suggestion Determination and Presentation

People use computing devices (or systems) for a wide variety of purposes. Computing devices can provide different kinds of functionality. Users can utilize their computing devices to produce information, access information, and share information. In some cases, users can utilize computing devices to interact or engage with a conventional social networking system (i.e., a social networking service, a social network, etc.). For example, users can provide, post, or publish content items, such as text, notes, status updates, links, pictures, videos, and audio, via the social networking system. Users can also access and experience content of almost every variety of type and form.

As a social networking system learns more about a user, the experience of the user in connection with the social networking system can be enhanced. For example, interactions on a social networking system, such as posts, connections between users, messages between users, and the like, can relate to events in a user's life taking place outside the social networking system (e.g., vacations, graduations, marriages, etc.). The social networking system interactions of the user as well as those of the user's connections on the social networking system can provide important information that can be leveraged by the social networking system to optimize the presentation of relevant content, advertising, and other services to the user.

However, it continues to be a challenge for social networking systems rooted in computer technology to utilize relevant information regarding interactions of a user and his or her connections to provide content that is of interest to the user. Such information, when available, can be used to provide suggestions or assistance on topics of interest to the user based on her social network. However, the sheer magnitude of information maintained by the social networking system can render retrieval of such information by a user difficult or cumbersome. Further, an attempt by the social networking system to automatically retrieve and present relevant information for the user can result in a large volume of available information that could overwhelm the user.

Therefore, an improved approach can be beneficial for addressing or alleviating various concerns associated with conventional approaches. The disclosed technology is implemented in computer technology to provide various types of suggestions and assistance for a user based on consideration of various factors that leverage relevant information maintained by a social networking system. The various types of suggestions and assistance for a user can relate to many different types of topics and activities, such as travel planning to name just one example, In the example of travel planning, the social networking system may utilize available information about a user, the user's connections, and other users on the social networking system to determine potential travel destinations and relevant information about those destinations. A social networking system may also use available information to determine which of a user's connections may have relevant information about a potential travel destination, notify the user of these connections, and provide an opportunity for the user to ask for travel assistance and advice from those connections.

While the present disclosure is discussed in more detail herein within the context of providing travel assistance as an example, it should be appreciated that the present disclosure may be applied to provide any other suitable types of assistance and suggestions. For example, users interested in reading a new book may be provided with a list of popular books, and connections who have read each of the suggested books. In addition, users can search for a particular book and see a list of users who have previously read the particular book. In other example, users may be looking for a plumber or gardener for their home. The present disclosure may be used to search for a user's connections who have experience with different plumbers or gardeners in the same area as the user who might be able to provide the user with guidance and advice. The technology disclosed herein may be applied to a variety of other scenarios and circumstances.

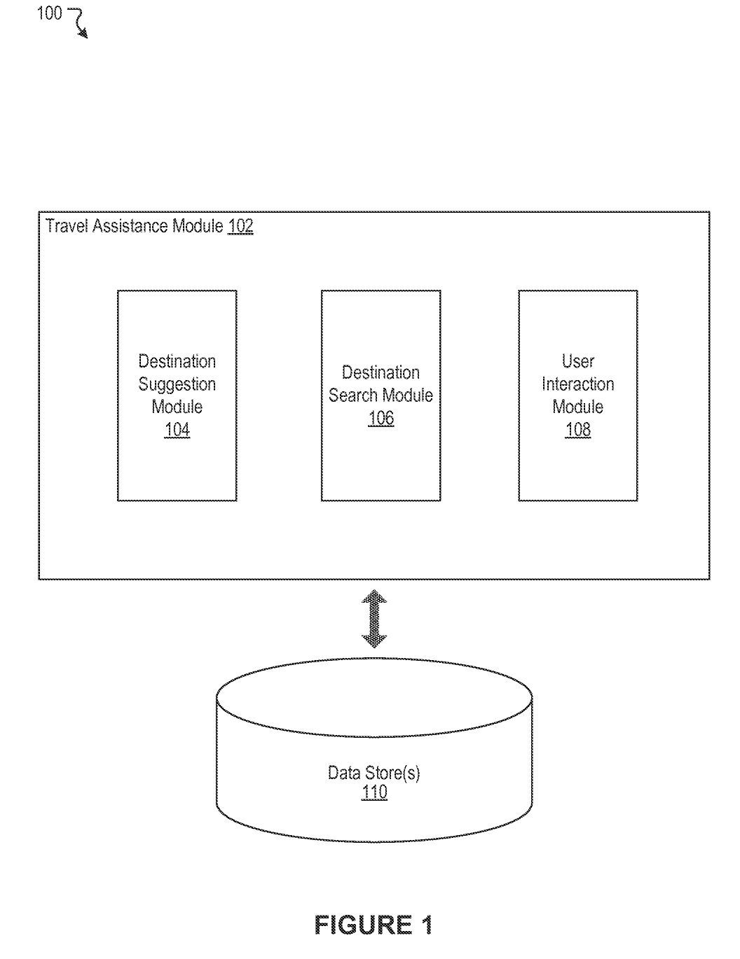

FIG. 1 illustrates an example system 100 including an example travel assistance module 102 configured to facilitate providing travel assistance to a user, according to an embodiment of the present disclosure. As shown in the example of FIG. 1, the travel assistance module 102 can include a destination suggestion module 104, a destination search module 106, and a user interaction module 108. In some instances, the example system 100 can include at least one data store 110. The components (e.g., modules, elements, etc.) shown in this figure and all figures herein are exemplary only, and other implementations may include additional, fewer, integrated, or different components. Some components may not be shown so as not to obscure relevant details.

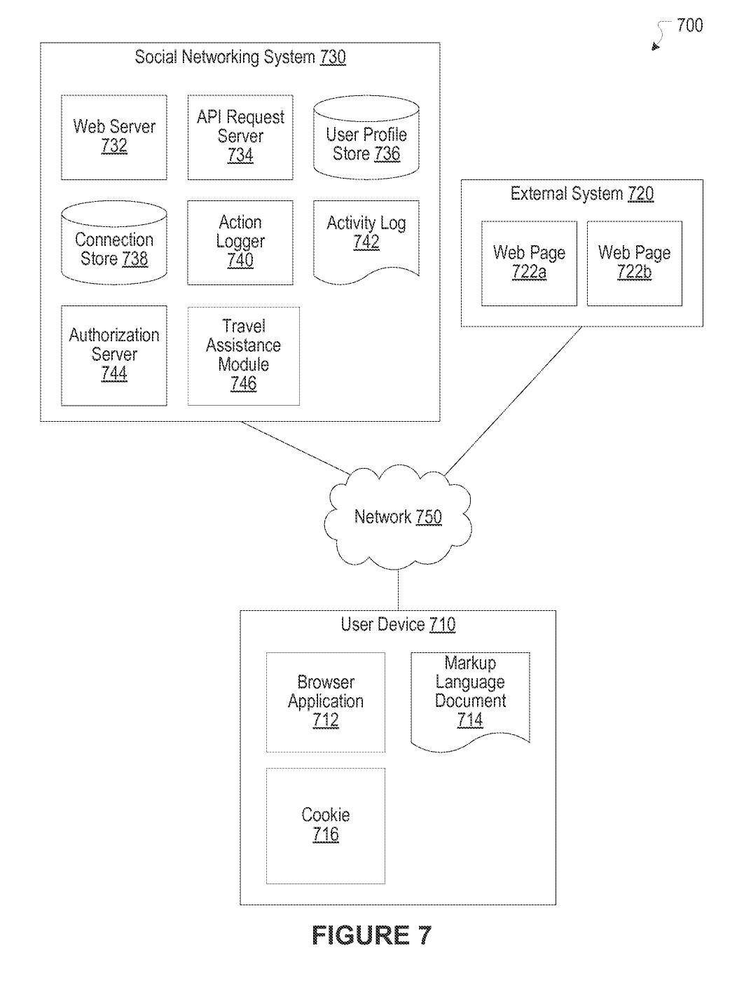

The travel assistance module 102 can be implemented, in part or in whole, as software, hardware, or any combination thereof. In general, a module as discussed herein can be associated with software, hardware, or any combination thereof. In some implementations, one or more functions, tasks, and/or operations of modules can be carried out or performed by software routines, software processes, hardware, and/or any combination thereof. In some cases, the travel assistance module 102 can be implemented, in part or in whole, as software running on one or more computing devices or systems, such as on a server computing system or a user (or client) computing system. For example, the travel assistance module 102 or at least a portion thereof can be implemented as or within an application (e.g., app), a program, or an applet, etc., running on a user computing device or a client computing system, such as the user device 710 of FIG. 7. In another example, the travel assistance module 102 or at least a portion thereof can be implemented using one or more computing devices or systems that include one or more servers, such as network servers or cloud servers. In some instances, the travel assistance module 102 can, in part or in whole, be implemented within or configured to operate in conjunction with a social networking system (or service), such as the social networking system 730 of FIG. 7. It should be understood that there can be many variations or other possibilities.

The destination suggestion module 104 can be configured to provide one or more travel destination suggestions to a user based on consideration of a variety of factors. In certain embodiments, these factors may include user travel preferences (e.g., length of trip, travel distance, etc.), dates of travel, the time of year, any special events taking place in potential destinations, the travel history of the user and the user's connections on the social networking system, and the residential history of the user and the user's connections on the social networking system, among other possible factors. Once these various factors have been considered, the user may be presented with one or more travel destination suggestions, as well as relevant information relating to each of those travel destinations. The designation suggestion module 104 is discussed in more detail herein.

The destination search module 106 can be configured to receive a search request from a user specifying a particular travel destination, and provide relevant information that may be of relevance or interest to the user in planning a trip to the particular destination. In certain embodiments, the search module 106 can be configured to receive a potential travel destination from a user, and conduct a query for information relating to the potential travel destination. The results of this query might include a listing of the user's connections on the social networking system that have previously visited or lived in the potential travel destination, as well as posts made by the user's connections on the social networking system relating to the potential travel destination. The user may then use the information provided by the query results to help plan a trip. The destination search module 106 is discussed in more detail herein.

The user interaction module 108 can be configured to give a user an opportunity to interact and communicate with other users on the social networking system who may be able to provide travel assistance. For example, as discussed above, the destination suggestion module 104 may provide a listing of potential travel destinations, as well as a listing of the user's connections on the social networking system who have visited or lived in each of the potential travel destinations. Similarly, when a user performs a search for a specific potential travel destination, the destination search module 106 may provide a listing of the user's connections on the social networking system who have visited or lived in the potential travel destination specified by the user. The user interaction module 108 can be configured to allow the user to send a message to any of these connections on the social networking system to ask for travel advice relating to any of the potential travel destinations. The user interaction module 108 can also be configured to allow the user to create a post on the social networking system, and to invite other users (e.g., the user's connections on the social networking system) to provide travel assistance by commenting on the post or answering questions in the post. The user can populate the post with questions for the user's connections who have visited or lived in the potential travel destination, or may create multiple posts with different questions in each post. In certain embodiments, the user interaction module 108 can provide to the user a set of commonly asked, recommended questions, such as “When is the best time of year to visit this city?” and “What are the best places to eat?” The user can select questions from the commonly asked, recommended questions to include in posts so that other users can respond. Further, the user can select which of the user's connections are invited to comment in or participate in each post. In this way, the user can interact with other users on the social networking system to receive travel assistance and advice from other users who may be more familiar with the potential travel destination.

Furthermore, in some embodiments, the travel assistance module 102 can be configured to communicate and/or operate with the at least one data store 110, as shown in the example system 100. The data store 110 can be configured to store and maintain various types of data. In some implementations, the data store 110 can store information associated with the social networking system (e.g., the social networking system 730 of FIG. 7). The information associated with the social networking system can include data about users, user identifiers, social connections, social interactions, profile information, demographic information, locations, geo-fenced areas, maps, places, events, pages, groups, posts, communications, content, feeds, account settings, privacy settings, a social graph, and various other types of data. In some embodiments, the data store 110 can store information that is utilized by the travel assistance module 102. For instance, the data store 110 can store posts made by users on the social networking system, posts on the social networking system in which users have been tagged, interactions between users on the social networking system, user preferences, post popularity or relevance information, user friendship coefficient information, and any other information that may be used to carry out the present disclosure. It is contemplated that there can be many variations or other possibilities.

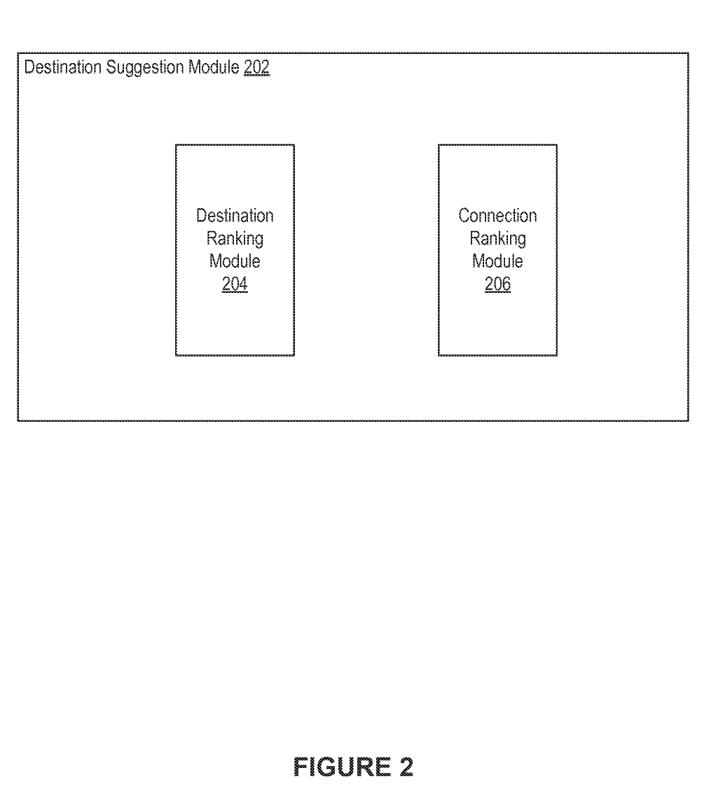

FIG. 2 illustrates an example destination suggestion module 202 configured to provide suggestions of potential travel destinations, according to an embodiment of the present disclosure. In some embodiments, the destination suggestion module 104 of FIG. 1 can be implemented by the example destination suggestion module 202. As shown in FIG. 2, the destination suggestion module 202 can include a destination ranking module 204 and a connection ranking module 206.

The destination ranking module 204 can be configured to determine one or more potential travel destinations, and to rank and/or filter them based on various destination ranking criteria. The ranked potential travel destinations may then be presented to a user to help the user plan a future trip. The destination ranking module 204 may receive various inputs that may be used in ranking potential travel destinations. For example, the destination ranking module 204 may consider any or all of the following factors: where the user currently lives; approximate dates of travel; approximate duration of the trip; and whether the user wants to travel domestically or internationally, among other factors. The user may be asked to submit some information, and other information may be available to the social networking system without additional user input. For example, the user may be asked to specify the approximate dates of travel and the approximate duration of the trip, and the destination ranking module 204 may already be able to determine where the user currently resides (e.g., if the user has specified this information in a profile on the social networking system).

The destination ranking module 204 can be configured to use any relevant information to rank potential travel destinations. In one example, the destination ranking module 204 may consider the approximate dates of travel or the time of year to determine popular travel destinations for the specified dates or time of year. This determination may involve looking at data for other users on the social networking system to see popular travel locations for other users during the specified dates or time of year. The destination ranking module 204 may be able to determine popular travel destinations by looking at available location-based information, such as user posts that are tagged with date and location information (e.g., geo-tagged photographs or videos, status updates mentioning a particular location, etc.). For example, if a user specifies that he or she is planning a trip in April, the destination ranking module 204 may look to see what locations were most commonly tagged in posts in April in previous years. The destination ranking module 204 may also consider publicly available information about popular travel destinations (e.g., Colorado in the winter for skiing, Washington D.C. in the spring for cherry blossoms, etc.)

The destination ranking module 204 may also consider the approximate duration of travel and where the user currently resides to determine appropriate destination suggestions. For example, if the user resides in Palo Alto, Calif., and is planning a three-day trip, it may be impractical to suggest a three-day trip to Sydney, Australia. In this case, the destination ranking module 204 may give greater preference to nearby or domestic destinations, as opposed to more remote international destinations. Conversely, if the user is planning a 14-day trip, then the destination ranking module 204 may give preference to more remote destinations or, at least, give further destinations equal consideration to closer destinations. In certain embodiments, users may be asked to specify whether they would like to take a domestic trip or an international trip, and potential destinations may be filtered out and/or removed from consideration based on the user specification.

In certain embodiments, locations that are too close to a user's current place of residence (i.e., locations whose distance from the user's place of residence does not satisfy a distance threshold) may be given lower priority, or removed from consideration altogether. For example, when the distance threshold is not satisfied, the destination ranking module 204 may not identify San Francisco, Calif. as a travel destination for users living in Palo Alto, Calif.

The destination ranking module 204 may also consider in its ranking of potential travel destinations how many of the user's connections on the social networking system have visited or lived in the potential travel destination. As described above, this information may be available to the social networking system and the destination ranking module 204 via user check-ins, geo-tagged posts, user-provided residential history information, and the like.

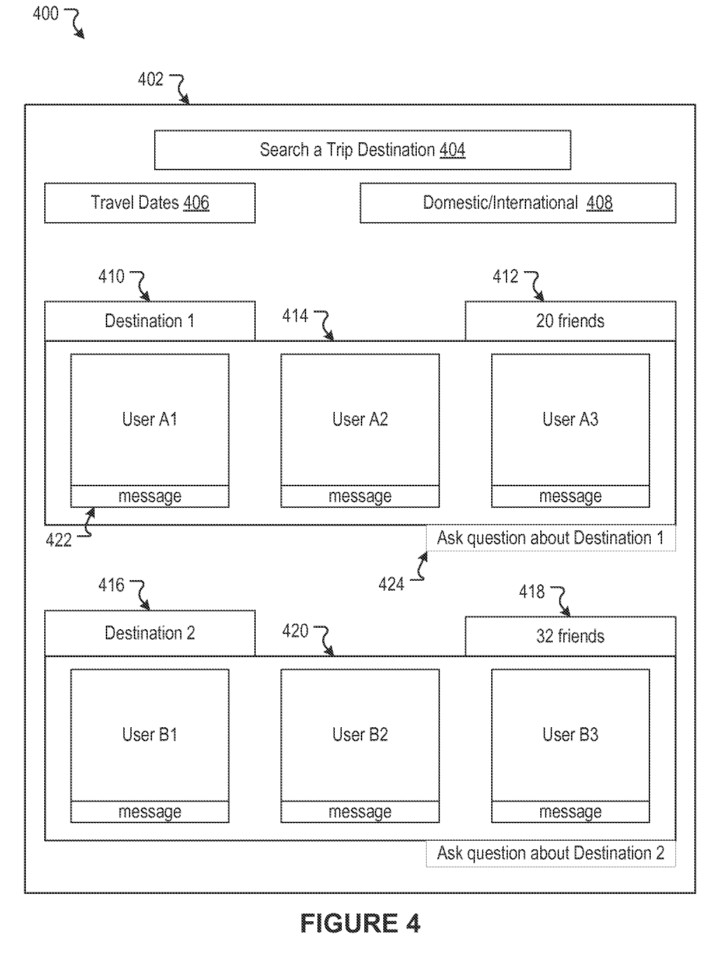

In addition to providing a user with a list of potential travel destinations, the user may also be provided with a list of connections on the social networking system that may be of assistance in planning a trip to each of the potential travel destinations. The connection ranking module 206 can be configured to determine which of a user's connections on a social networking system have previously visited or lived in the various potential travel destinations, and then, for each of the potential travel destinations, rank these connections based on various connection ranking criteria. These connections may then be presented to the user alongside each of the potential travel destinations so that the user can contact one or more connections for assistance in planning their trip (see, e.g., FIG. 4, discussed in greater detail below).

In certain embodiments, connections may be ranked based, at least in part, on a “friendship coefficient” which determines the affinity between two users. This ranking reflects a principle that users may be more inclined to reach out to and ask for travel assistance from connections that, for example, they are closer to, rather than asking for travel assistance from connections that, for example, they have not communicated or interacted with in a long time. The friendship coefficient may take into account the quantity and quality of interactions between the two users on the social networking system as well as friendship designations selected by the users (e.g., designating a particular user as a “close friend”).

In certain embodiments, the connection ranking module 206 may also take into account various factors indicative of how familiar a connection might be with the potential travel destination, i.e., destination familiarity information. For example, the connection ranking module 206 may consider whether the connection has lived in the potential travel destination, and for how long, or how many times the connection has visited the potential travel destination, and for how long. Similarly, the connection ranking module 206 may consider how long it has been since the connection lived in or visited the potential travel destination, as a more recent experience in the potential travel destination may be more valuable than an older experience. As another example, the connection ranking module 206 may also consider whether the connection visited or lived in the potential travel destination around the same time of year as the dates specified by the user for their potential trip.

The connection ranking module 206 may also, in certain embodiments, consider post popularity or relevance information. For example, it can be determined that a connection has visited the potential travel destination based on the connection's photo album that is geo-tagged with the location of the potential travel destination. In this example, the connection ranking module 206 may consider the popularity of the photo album post (e.g., positive reviews, likes, comments, number of people tagged in the event, number of shares, etc.) to assess the quality of the connection's experience in the potential travel destination.

In certain embodiments, the connection ranking module 206 may consider how many times the connection has provided travel assistance to other users on the potential travel destination. For example, if Paris, France is listed as a potential travel destination, then the connection ranking module 206 may consider whether a connection has previously provided travel assistance to other users planning trips to Paris, France.

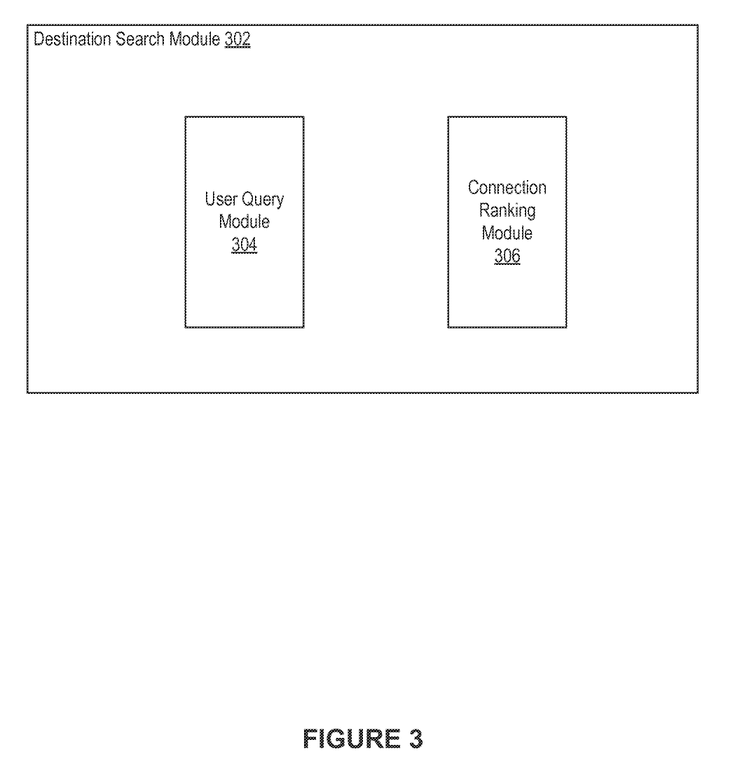

FIG. 3 illustrates an example destination search module 302 configured to receive a user query (or search) identifying a particular travel destination, and provide relevant information about the particular travel destination, according to an embodiment of the present disclosure. In some embodiments, the destination search module 106 of FIG. 1 can be implemented by the example destination suggestion module 302. As shown in FIG. 3, the destination search module 302 can include a user query module 304 and a connection ranking module 306.

The user query module 304 can be configured to receive a user specified search for a particular travel destination. In this embodiment, rather than providing a user with a list of potential travel destinations, as was the case with the destination suggestion module 202 of FIG. 2, the user has one or more travel destinations in mind, and is seeking travel assistance specifically for those one or more travel destinations. The user may enter the one or more travel destinations into a search bar to perform a search for information relevant to each travel destination.

In response to a search, the connection ranking module 306 can be configured to determine which of the user's connections on the social networking system have previously visited or lived in the user-specified travel destination. The connection ranking module 306 then can rank these connections based on various connection ranking criteria. In certain embodiments, the connection ranking module 306 may be implemented similarly to the connection ranking module 206 discussed above with reference to FIG. 2.

FIG. 4 illustrates an example scenario 400 associated with providing travel assistance to a user, according to an embodiment of the present disclosure. The example scenario 400 illustrates an example interface 402 for utilizing a social networking system (such as the social networking system 730 of FIG. 7). As shown in FIG. 4, the example interface 402 presents a list of potential travel destinations 410, 416 for consideration by a user. The user can specify approximate travel dates using a button 406, and can specify whether they want to take a domestic trip or an international trip using a button 408.

Each potential travel destination 410, 416 is presented with a list of users 414, 420 that may be able to provide travel assistance for the particular potential travel destination. The list of users 414, 420 may be limited to a user's connections on the social networking system or, in certain embodiments, connections of connections (e.g., “friends of friends”).

In FIG. 4, a first potential travel destination, “Destination 1”, includes a list of users 414 which includes User A1, User A2, and User A3. It is also shown that there are 20 total connections (“20 friends”) who have either previously visited or lived in Destination 1. The user can click a button 412 to open up a list of all twenty connections. The user can send a message to each user individually to ask questions about the potential travel destinations. For example, the user can message User A1 by clicking a button 422. Alternatively, the user can create a post requesting travel advice by clicking a button 424. Within the post, the user can ask specific questions about the potential travel destination, or ask for general advice and tips from the user's connections who have been to the potential travel destination. The user can invite as many or as few of his or her connections to participate in the post and provide travel advice.

In certain embodiments, the presentation of each connection may include a post by that connection that is relevant to the potential travel destination. For example, if User A1 has previously posted a photograph from Destination 1, then the box marked as “User A1” in FIG. 4 might include the connection's name (“User A1”), as well as User A1's photograph from Destination 1. Similarly, if User A2 has posted a video from Destination 1, then the box marked as “User A2” might include a screenshot of the video, or the video itself. If each user has more than one post that is related to the potential travel destination, then these posts may be ranked according to various post ranking criteria. In certain embodiments, the post ranking criteria may consider the popularity of each post (e.g., positive reviews, likes, comments, number of people tagged in the event, number of shares, etc.); the age of the post (e.g., newer posts are prioritized higher); the time of year of the post (e.g., posts that may be more relevant to the approximate travel dates specified by the user may be given greater priority); among other factors.

A user may also run a search for a particular travel destination using a search box 404. When the user runs a search for a particular travel destination, the user may be presented with a list of connections who have traveled to or lived in the particular travel destination. In certain embodiments, the user may be presented with one or more separate lists of connections. For example, the user may be presented with a first list of connections who currently live in or have previously lived in the particular travel destination, and another list of connections who have visited the particular travel destination. In another embodiment, a list of connections who currently live in the particular travel destination may be presented separately from a list of connections who have previously lived in the particular travel destination. This presentation would allow the user to reach out to those connections who are currently living in the particular travel destination and may want to meet with the user during the user's trip.

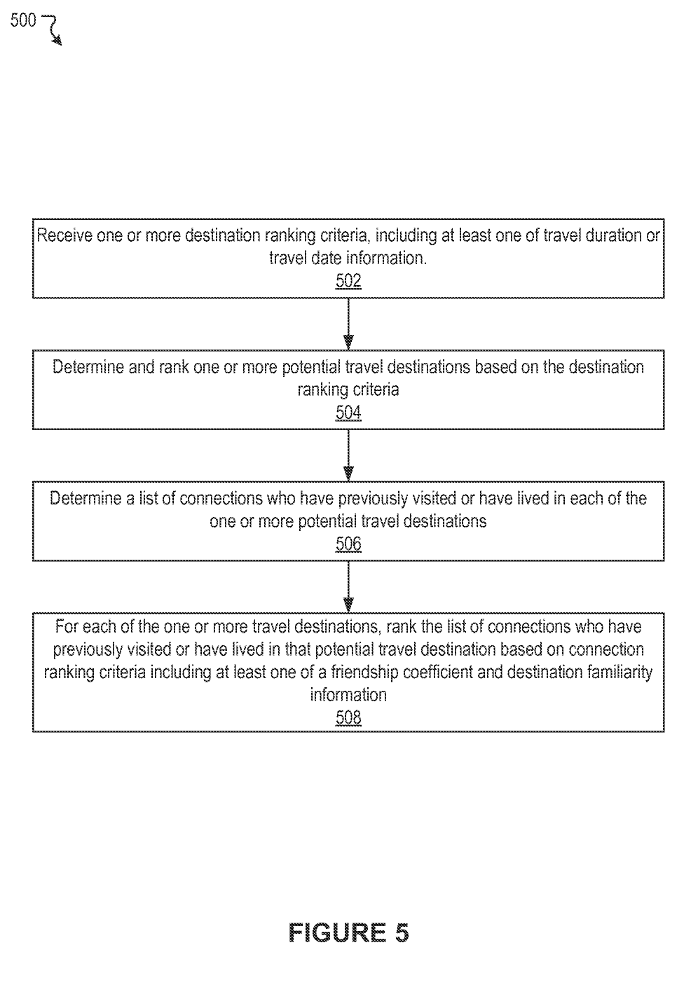

FIG. 5 illustrates an example method 500 associated with providing potential travel destinations, according to an embodiment of the present disclosure. It should be appreciated that there can be additional, fewer, or alternative steps performed in similar or alternative orders, or in parallel, within the scope of the various embodiments discussed herein unless otherwise stated.

At block 502, the example method 500 can receive one or more destination ranking criteria, including at least one of a travel duration or travel date information. At block 504, the example method 500 can determine and rank one or more potential travel destinations based on the destination ranking criteria. At block 506, the example method 500 can determine a list of connections on a social networking system who have previously visited or have lived in each of the one or more potential travel destinations. At block 508, the example method 500 can, for each of the one or more potential travel destinations, rank the list of connections who have previously visited or have lived in that potential travel destination based on connection ranking criteria, including at least one of a friendship coefficient or destination familiarity information.

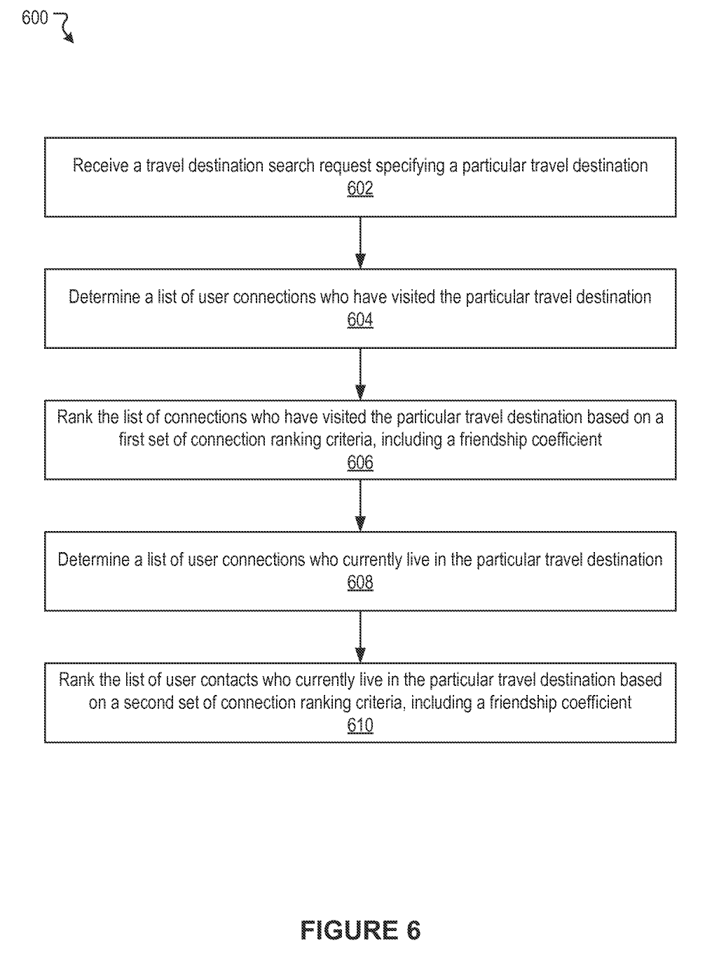

FIG. 6 illustrates an example method 600 associated with providing travel assistance for a particular travel destination, according to an embodiment of the present disclosure. It should be appreciated that there can be additional, fewer, or alternative steps performed in similar or alternative orders, or in parallel, within the scope of the various embodiments discussed herein unless otherwise stated.

At block 602, the example method 600 can receive a travel destination search request specifying a particular travel destination. At block 604, the example method 600 can determine a list of user connections who have visited the particular travel destination. At block 606, the example method 600 can rank the list of connections who have visited the particular travel destination based on a first set of connection ranking criteria, including a friendship coefficient. At block 608, the example method 600 can determine a list of user connections who currently live in the particular travel destination. At block 610, the example method 610 can rank the list of user contacts who currently live in the particular travel destination based on a second set of connection ranking criteria, including a friendship coefficient.

### Social Networking System—Example Implementation

FIG. 7 illustrates a network diagram of an example system 700 that can be utilized in various scenarios, in accordance with an embodiment of the present disclosure. The system 700 includes one or more user devices 710, one or more external systems 720, a social networking system (or service) 730, and a network 750. In an embodiment, the social networking service, provider, and/or system discussed in connection with the embodiments described above may be implemented as the social networking system 730. For purposes of illustration, the embodiment of the system 700, shown by FIG. 7, includes a single external system 720 and a single user device 710. However, in other embodiments, the system 700 may include more user devices 710 and/or more external systems 720. In certain embodiments, the social networking system 730 is operated by a social network provider, whereas the external systems 720 are separate from the social networking system 730 in that they may be operated by different entities. In various embodiments, however, the social networking system 730 and the external systems 720 operate in conjunction to provide social networking services to users (or members) of the social networking system 730. In this sense, the social networking system 730 provides a platform or backbone, which other systems, such as external systems 720, may use to provide social networking services and functionalities to users across the Internet.

The user device 710 comprises one or more computing devices (or systems) that can receive input from a user and transmit and receive data via the network 750. In one embodiment, the user device 710 is a conventional computer system executing, for example, a Microsoft Windows compatible operating system (OS), Apple OS X, and/or a Linux distribution. In another embodiment, the user device 710 can be a computing device or a device having computer functionality, such as a smart-phone, a tablet, a personal digital assistant (PDA), a mobile telephone, a laptop computer, a wearable device (e.g., a pair of glasses, a watch, a bracelet, etc.), a camera, an appliance, etc. The user device 710 is configured to communicate via the network 750. The user device 710 can execute an application, for example, a browser application that allows a user of the user device 710 to interact with the social networking system 730. In another embodiment, the user device 710 interacts with the social networking system 730 through an application programming interface (API) provided by the native operating system of the user device 710, such as iOS and ANDROID. The user device 710 is configured to communicate with the external system 720 and the social networking system 730 via the network 750, which may comprise any combination of local area and/or wide area networks, using wired and/or wireless communication systems.

In one embodiment, the network 750 uses standard communications technologies and protocols. Thus, the network 750 can include links using technologies such as Ethernet, 702.11, worldwide interoperability for microwave access (WiMAX), 3G, 4G, CDMA, GSM, LTE, digital subscriber line (DSL), etc. Similarly, the networking protocols used on the network 750 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 750 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 710 may display content from the external system 720 and/or from the social networking system 730 by processing a markup language document 714 received from the external system 720 and from the social networking system 730 using a browser application 712. The markup language document 714 identifies content and one or more instructions describing formatting or presentation of the content. By executing the instructions included in the markup language document 714, the browser application 712 displays the identified content using the format or presentation described by the markup language document 714. For example, the markup language document 714 includes instructions for generating and displaying a web page having multiple frames that include text and/or image data retrieved from the external system 720 and the social networking system 730. In various embodiments, the markup language document 714 comprises a data file including extensible markup language (XML) data, extensible hypertext markup language (XHTML) data, or other markup language data. Additionally, the markup language document 714 may include JavaScript Object Notation (JSON) data, JSON with padding (JSONP), and JavaScript data to facilitate data-interchange between the external system 720 and the user device 710. The browser application 712 on the user device 710 may use a JavaScript compiler to decode the markup language document 714.

The markup language document 714 may also include, or link to, applications or application frameworks such as FLASH™ or Unity™ applications, the SilverLight™ application framework, etc.

In one embodiment, the user device 710 also includes one or more cookies 716 including data indicating whether a user of the user device 710 is logged into the social networking system 730, which may enable modification of the data communicated from the social networking system 730 to the user device 710.

The external system 720 includes one or more web servers that include one or more web pages 722a, 722b, which are communicated to the user device 710 using the network 750. The external system 720 is separate from the social networking system 730. For example, the external system 720 is associated with a first domain, while the social networking system 730 is associated with a separate social networking domain. Web pages 722a, 722b, included in the external system 720, comprise markup language documents 714 identifying content and including instructions specifying formatting or presentation of the identified content.

The social networking system 730 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 730 may be administered, managed, or controlled by an operator. The operator of the social networking system 730 may be a human being, an automated application, or a series of applications for managing content, regulating policies, and collecting usage metrics within the social networking system 730. Any type of operator may be used.

Users may join the social networking system 730 and then add connections to any number of other users of the social networking system 730 to whom they desire to be connected. As used herein, the term “friend” refers to any other user of the social networking system 730 to whom a user has formed a connection, association, or relationship via the social networking system 730. For example, in an embodiment, if users in the social networking system 730 are represented as nodes in the social graph, the term “friend” can refer to an edge formed between and directly connecting two user nodes.

Connections may be added explicitly by a user or may be automatically created by the social networking system 730 based on common characteristics of the users (e.g., users who are alumni of the same educational institution). For example, a first user specifically selects a particular other user to be a friend. Connections in the social networking system 730 are usually in both directions, but need not be, so the terms “user” and “friend” depend on the frame of reference. Connections between users of the social networking system 730 are usually bilateral (“two-way”), or “mutual,” but connections may also be unilateral, or “one-way.” For example, if Bob and Joe are both users of the social networking system 730 and connected to each other, Bob and Joe are each other's connections. If, on the other hand, Bob wishes to connect to Joe to view data communicated to the social networking system 730 by Joe, but Joe does not wish to form a mutual connection, a unilateral connection may be established. The connection between users may be a direct connection; however, some embodiments of the social networking system 730 allow the connection to be indirect via one or more levels of connections or degrees of separation.

In addition to establishing and maintaining connections between users and allowing interactions between users, the social networking system 730 provides users with the ability to take actions on various types of items supported by the social networking system 730. These items may include groups or networks (i.e., social networks of people, entities, and concepts) to which users of the social networking system 730 may belong, events or calendar entries in which a user might be interested, computer-based applications that a user may use via the social networking system 730, transactions that allow users to buy or sell items via services provided by or through the social networking system 730, and interactions with advertisements that a user may perform on or off the social networking system 730. These are just a few examples of the items upon which a user may act on the social networking system 730, and many others are possible. A user may interact with anything that is capable of being represented in the social networking system 730 or in the external system 720, separate from the social networking system 730, or coupled to the social networking system 730 via the network 750.

The social networking system 730 is also capable of linking a variety of entities. For example, the social networking system 730 enables users to interact with each other as well as external systems 720 or other entities through an API, a web service, or other communication channels. The social networking system 730 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 730. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 730 modifies edges connecting the various nodes to reflect the relationships and interactions.

The social networking system 730 also includes user-generated content, which enhances a user's interactions with the social networking system 730. User-generated content may include anything a user can add, upload, send, or “post” to the social networking system 730. For example, a user communicates posts to the social networking system 730 from a user device 710. Posts may include data such as status updates or other textual data, location information, images such as photos, videos, links, music or other similar data and/or media. Content may also be added to the social networking system 730 by a third party. Content “items” are represented as objects in the social networking system 730. In this way, users of the social networking system 730 are encouraged to communicate with each other by posting text and content items of various types of media through various communication channels. Such communication increases the interaction of users with each other and increases the frequency with which users interact with the social networking system 730.

The social networking system 730 includes a web server 732, an API request server 734, a user profile store 736, a connection store 738, an action logger 740, an activity log 742, and an authorization server 744. In an embodiment of the invention, the social networking system 730 may include additional, fewer, or different components for various applications. Other components, such as network interfaces, security mechanisms, load balancers, failover servers, management and network operations consoles, and the like are not shown so as to not obscure the details of the system.

The user profile store 736 maintains information about user accounts, including biographic, demographic, and other types of descriptive information, such as work experience, educational history, hobbies or preferences, location, and the like that has been declared by users or inferred by the social networking system 730. This information is stored in the user profile store 736 such that each user is uniquely identified. The social networking system 730 also stores data describing one or more connections between different users in the connection store 738. The connection information may indicate users who have similar or common work experience, group memberships, hobbies, or educational history. Additionally, the social networking system 730 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 730, such as non-person entities, buckets, cluster centers, images, interests, pages, external systems, concepts, and the like are also stored in the connection store 738.

The social networking system 730 maintains data about objects with which a user may interact. To maintain this data, the user profile store 736 and the connection store 738 store instances of the corresponding type of objects maintained by the social networking system 730. Each object type has information fields that are suitable for storing information appropriate to the type of object. For example, the user profile store 736 contains data structures with fields suitable for describing a user's account and information related to a user's account. When a new object of a particular type is created, the social networking system 730 initializes a new data structure of the corresponding type, assigns a unique object identifier to it, and begins to add data to the object as needed. This might occur, for example, when a user becomes a user of the social networking system 730, the social networking system 730 generates a new instance of a user profile in the user profile store 736, assigns a unique identifier to the user account, and begins to populate the fields of the user account with information provided by the user.

The connection store 738 includes data structures suitable for describing a user's connections to other users, connections to external systems 720 or connections to other entities. The connection store 738 may also associate a connection type with a user's connections, which may be used in conjunction with the user's privacy setting to regulate access to information about the user. In an embodiment of the invention, the user profile store 736 and the connection store 738 may be implemented as a federated database.

Data stored in the connection store 738, the user profile store 736, and the activity log 742 enables the social networking system 730 to generate the social graph that uses nodes to identify various objects and edges connecting nodes to identify relationships between different objects. For example, if a first user establishes a connection with a second user in the social networking system 730, user accounts of the first user and the second user from the user profile store 736 may act as nodes in the social graph. The connection between the first user and the second user stored by the connection store 738 is an edge between the nodes associated with the first user and the second user. Continuing this example, the second user may then send the first user a message within the social networking system 730. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 730 (or, alternatively, in an image maintained by another system outside of the social networking system 730). The image may itself be represented as a node in the social networking system 730. This tagging action may create edges between the first user and the second user as well as create an edge between each of the users and the image, which is also a node in the social graph. In yet another example, if a user confirms attending an event, the user and the event are nodes obtained from the user profile store 736, where the attendance of the event is an edge between the nodes that may be retrieved from the activity log 742. By generating and maintaining the social graph, the social networking system 730 includes data describing many different types of objects and the interactions and connections among those objects, providing a rich source of socially relevant information.

The web server 732 links the social networking system 730 to one or more user devices 710 and/or one or more external systems 720 via the network 750. The web server 732 serves web pages, as well as other web-related content, such as Java, JavaScript, Flash, XML, and so forth. The web server 732 may include a mail server or other messaging functionality for receiving and routing messages between the social networking system 730 and one or more user devices 710. The messages can be instant messages, queued messages (e.g., email), text and SMS messages, or any other suitable messaging format.

The API request server 734 allows one or more external systems 720 and user devices 710 to call access information from the social networking system 730 by calling one or more API functions. The API request server 734 may also allow external systems 720 to send information to the social networking system 730 by calling APIs. The external system 720, in one embodiment, sends an API request to the social networking system 730 via the network 750, and the API request server 734 receives the API request. The API request server 734 processes the request by calling an API associated with the API request to generate an appropriate response, which the API request server 734 communicates to the external system 720 via the network 750. For example, responsive to an API request, the API request server 734 collects data associated with a user, such as the user's connections that have logged into the external system 720, and communicates the collected data to the external system 720. In another embodiment, the user device 710 communicates with the social networking system 730 via APIs in the same manner as external systems 720.

The action logger 740 is capable of receiving communications from the web server 732 about user actions on and/or off the social networking system 730. The action logger 740 populates the activity log 742 with information about user actions, enabling the social networking system 730 to discover various actions taken by its users within the social networking system 730 and outside of the social networking system 730. Any action that a particular user takes with respect to another node on the social networking system 730 may be associated with each user's account, through information maintained in the activity log 742 or in a similar database or other data repository. Examples of actions taken by a user within the social networking system 730 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 730, the action is recorded in the activity log 742. In one embodiment, the social networking system 730 maintains the activity log 742 as a database of entries. When an action is taken within the social networking system 730, an entry for the action is added to the activity log 742. The activity log 742 may be referred to as an action log.

Additionally, user actions may be associated with concepts and actions that occur within an entity outside of the social networking system 730, such as an external system 720 that is separate from the social networking system 730. For example, the action logger 740 may receive data describing a user's interaction with an external system 720 from the web server 732. In this example, the external system 720 reports a user's interaction according to structured actions and objects in the social graph.

Other examples of actions where a user interacts with an external system 720 include a user expressing an interest in an external system 720 or another entity, a user posting a comment to the social networking system 730 that discusses an external system 720 or a web page 722a within the external system 720, a user posting to the social networking system 730 a Uniform Resource Locator (URL) or other identifier associated with an external system 720, a user attending an event associated with an external system 720, or any other action by a user that is related to an external system 720. Thus, the activity log 742 may include actions describing interactions between a user of the social networking system 730 and an external system 720 that is separate from the social networking system 730.

The authorization server 744 enforces one or more privacy settings of the users of the social networking system 730. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 720, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 720. One embodiment allows the specification of the set of entities to comprise an enumeration of entities. For example, the user may provide a list of external systems 720 that are allowed to access certain information. Another embodiment allows the specification to comprise a set of entities along with exceptions that are not allowed to access the information. For example, a user may allow all external systems 720 to access the user's work information, but specify a list of external systems 720 that are not allowed to access the work information. Certain embodiments call the list of exceptions that are not allowed to access certain information a “block list”. External systems 720 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 744 contains logic to determine if certain information associated with a user can be accessed by a user's friends, external systems 720, and/or other applications and entities. The external system 720 may need authorization from the authorization server 744 to access the user's more private and sensitive information, such as the user's work phone number. Based on the user's privacy settings, the authorization server 744 determines if another user, the external system 720, an application, or another entity is allowed to access information associated with the user, including information about actions taken by the user.

In some embodiments, the social networking system 730 can include a travel assistance module 746. The travel assistance module 746 can, for example, be implemented as the travel assistance module 102 of FIG. 1. As discussed previously, it should be appreciated that there can be many variations or other possibilities. For example, in some instances, the travel assistance module 746 (or at least a portion thereof) can be included in the user device 710. Other features of the travel assistance module 746 are discussed herein in connection with the travel assistance module 102.

### Hardware Implementation

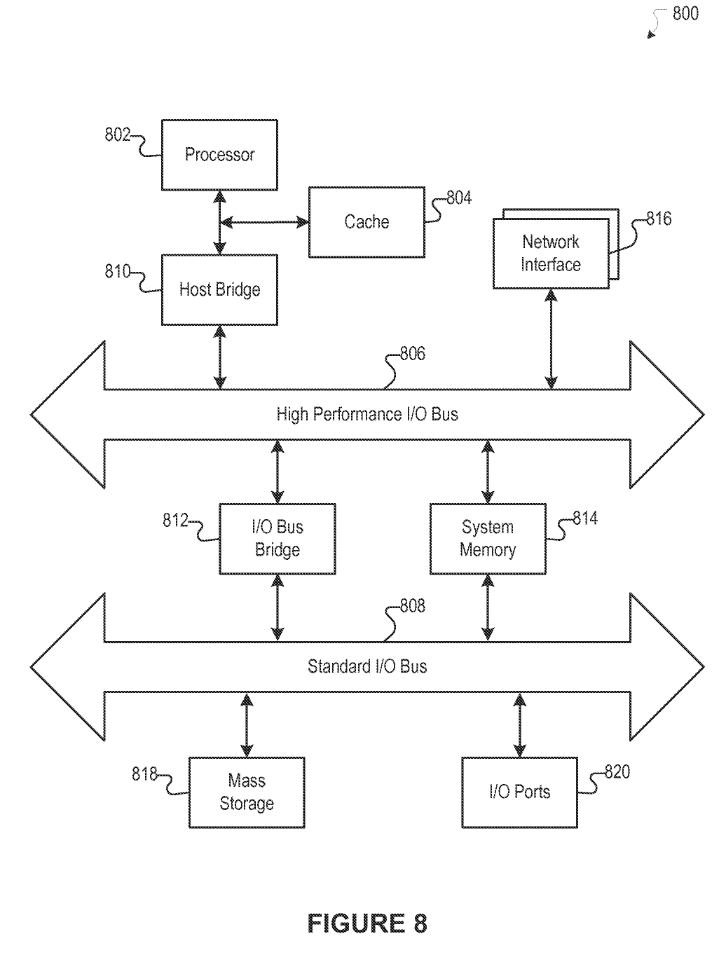

The foregoing processes and features can be implemented by a wide variety of machine and computer system architectures and in a wide variety of network and computing environments. FIG. 8 illustrates an example of a computer system 800 that may be used to implement one or more of the embodiments described herein in accordance with an embodiment of the invention. The computer system 800 includes sets of instructions for causing the computer system 800 to perform the processes and features discussed herein. The computer system 800 may be connected (e.g., networked) to other machines. In a networked deployment, the computer system 800 may operate in the capacity of a server machine or a client machine in a client-server network environment, or as a peer machine in a peer-to-peer (or distributed) network environment. In an embodiment of the invention, the computer system 800 may be the social networking system 730, the user device 710, and the external system 820, or a component thereof. In an embodiment of the invention, the computer system 800 may be one server among many that constitutes all or part of the social networking system 730.

The computer system 800 includes a processor 802, a cache 804, and one or more executable modules and drivers, stored on a computer-readable medium, directed to the processes and features described herein. Additionally, the computer system 800 includes a high performance input/output (I/O) bus 806 and a standard I/O bus 808. A host bridge 810 couples processor 802 to high performance I/O bus 806, whereas I/O bus bridge 812 couples the two buses 806 and 808 to each other. A system memory 814 and one or more network interfaces 816 couple to high performance I/O bus 806. The computer system 800 may further include video memory and a display device coupled to the video memory (not shown). Mass storage 818 and I/O ports 820 couple to the standard I/O bus 808. The computer system 800 may optionally include a keyboard and pointing device, a display device, or other input/output devices (not shown) coupled to the standard I/O bus 808. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 800, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 800 are described in greater detail below. In particular, the network interface 816 provides communication between the computer system 800 and any of a wide range of networks, such as an Ethernet (e.g., IEEE 802.3) network, a backplane, etc. The mass storage 818 provides permanent storage for the data and programming instructions to perform the above-described processes and features implemented by the respective computing systems identified above, whereas the system memory 814 (e.g., DRAM) provides temporary storage for the data and programming instructions when executed by the processor 802. The I/O ports 820 may be one or more serial and/or parallel communication ports that provide communication between additional peripheral devices, which may be coupled to the computer system 800.

The computer system 800 may include a variety of system architectures, and various components of the computer system 800 may be rearranged. For example, the cache 804 may be on-chip with processor 802. Alternatively, the cache 804 and the processor 802 may be packed together as a “processor module”, with processor 802 being referred to as the “processor core”. Furthermore, certain embodiments of the invention may neither require nor include all of the above components. For example, peripheral devices coupled to the standard I/O bus 808 may couple to the high performance I/O bus 806. In addition, in some embodiments, only a single bus may exist, with the components of the computer system 800 being coupled to the single bus. Moreover, the computer system 800 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 800 that, when read and executed by one or more processors, cause the computer system 800 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 800, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 802. Initially, the series of instructions may be stored on a storage device, such as the mass storage 818. However, the series of instructions can be stored on any suitable computer readable storage medium. Furthermore, the series of instructions need not be stored locally, and could be received from a remote storage device, such as a server on a network, via the network interface 816. The instructions are copied from the storage device, such as the mass storage 818, into the system memory 814 and then accessed and executed by the processor 802. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 800 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
receiving, by a computing system, travel information including at least one of a travel duration, dates of travel, or a particular destination;
determining, by the computing system, one or more potential travel destinations based on the travel information;
determining, by the computing system, for each of the one or more potential travel destinations, one or more connections who have previously visited or lived in the potential travel destination; and
ranking, by the computing system, for each of the one or more potential travel destinations, the one or more connections who have previously visited or lived in the potential travel destination based on connection ranking criteria.

2. The computer-implemented method of claim 1, wherein the travel information comprises a particular destination, and the method further comprises:
presenting a first list of connections comprising one or more connections who have previously visited the potential travel destination; and
presenting a second list of connections comprising one or more connections who have lived in the potential travel destination.

3. The computer-implemented method of claim 1, further comprising ranking the one or more potential travel destinations based on destination ranking criteria.

4. The computer-implemented method of claim 3, wherein the destination ranking criteria comprise dates of travel, and the ranking the one or more potential travel destinations comprises ranking the one or more potential travel destinations based on a popularity of each of the one or more potential travel destinations during the dates of travel.

5. The computer-implemented method of claim 3, wherein the destination ranking criteria comprise user residence location information.

6. The computer-implemented method of claim 5, wherein the destination ranking criteria further comprise travel duration, and the ranking the one or more potential travel destinations comprises determining whether a trip to a potential travel destination is practical based on the user residence location information and the travel duration.

7. The computer-implemented method of claim 1, wherein the connection ranking criteria comprise a friendship coefficient.

8. The computer-implemented method of claim 1, wherein the connection ranking criteria comprise destination familiarity information.

9. The computer-implemented method of claim 1, further comprising providing an option to message at least one of the one or more connections.

10. The computer-implemented method of claim 1, further comprising providing an option to invite at least one of the one or more connections to participate in a post related to at least one of the one or more potential travel destinations.

11. A system comprising:
at least one processor; and
a memory storing instructions that, when executed by the at least one processor, cause the system to perform:
receiving travel information including at least one of a travel duration, dates of travel, or a particular destination;
determining one or more potential travel destinations based on the travel information;
determining, for each of the one or more potential travel destinations, one or more connections who have previously visited or lived in the potential travel destination; and
ranking, for each of the one or more potential travel destinations, the one or more connections who have previously visited or lived in the potential travel destination based on connection ranking criteria.

12. The system of claim 11, wherein the memory stores further instructions that, when executed by the at least one processor, cause the system to further perform:
ranking the one or more potential travel destinations based on destination ranking criteria.

13. The system of claim 12, wherein the destination ranking criteria comprise dates of travel, and the ranking the one or more potential travel destinations comprises ranking the one or more potential travel destinations based on a popularity of each of the one or more potential travel destinations during the dates of travel.

14. The system of claim 12, wherein the destination ranking criteria comprise user residence location information.

15. The system of claim 14, wherein the destination ranking criteria further comprises travel duration, and the ranking the one or more potential travel destinations comprises determining whether a trip to a potential travel destination is practical based on the user residence location information and the travel duration.

16. A non-transitory computer-readable storage medium including instructions that, when executed by at least one processor of a computing system, cause the computing system to perform a method comprising:
receiving travel information including at least one of a travel duration, dates of travel, or a particular destination;
determining one or more potential travel destinations based on the travel information;
determining, for each of the one or more potential travel destinations, one or more connections who have previously visited or lived in the potential travel destination; and
ranking, for each of the one or more potential travel destinations, the one or more connections who have previously visited or lived in the potential travel destination based on connection ranking criteria.

17. The non-transitory computer-readable storage medium of claim 16, wherein the instructions, when executed by at least one processor of a computing system, cause the computing system to further perform:
ranking the one or more potential travel destinations based on destination ranking criteria.

18. The non-transitory computer-readable storage medium of claim 17, wherein the destination ranking criteria comprise dates of travel, and the ranking the one or more potential travel destinations comprises ranking the one or more potential travel destinations based on a popularity of each of the one or more potential travel destinations during the dates of travel.

19. The non-transitory computer-readable storage medium of claim 17, wherein the destination ranking criteria comprise user residence location information.

20. The non-transitory computer-readable storage medium of claim 19, wherein the destination ranking criteria further comprise travel duration, and the ranking the one or more potential travel destinations comprises determining whether a trip to a potential travel destination is practical based on the user residence location information and the travel duration.
